(19) United States
(12) Patent Application Publication
(10) Pub. No.: US 2003/0179816 A1
(43) Pub. Date: Sep. 25, 2003

(54) Auto power down for forced speed modes

(75) Inventors: Gary S. Huff, Laguna Hills, CA (US); Mark Berman, Newport Coast, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation

(21) Appl. No.: 10/231,066

(22) Filed: Aug. 30, 2002

Related U.S. Application Data
(60) Provisional application No. 60/398,603, filed on Jul. 26, 2002.
(60) Provisional application No. 60/365,806, filed on Mar. 21, 2002.

(51) Int. Cl. H04B 1/38

(52) U.S. Cl. 375/219

(57) ABSTRACT

The present invention relates to systems and methods for auto power down of transceivers operating using various speeds of connection. The present invention has a local transceiver connected to a remote transceiver via a plurality of wire pairs. The local transceiver is connected to its remote transceiver via a receive wire pair and a transmit wire pair. The local transceiver further comprises receive wire pair listening device connected to receive wire pair energy monitoring device and a system power down device. The local transceiver also comprises a signal transmission device for transmitting signals over the transmit wire pair to its remote transceiver. The remote transceiver may have a similar structure to the local transceiver. The receive wire pair listening device listens on the receive wire pair to determine if the remote transceiver is transmitting signals. If no signals are sent, the energy monitoring device will not detect any energy on the receive wire pair and local transceiver will be powered down. The receive wire pair is the only wire pair that is being monitored for presence of energy.

### CROSS-REFERENCE TO RELATED APPLICATIONS

This application claims priority to U.S. Provisional Patent Application No. 60/365,806, titled “Gigabit Ethernet Transceiver”, filed Mar. 21, 2002, the disclosure of which is incorporated herein by reference in its entirety.

This application claims priority to U.S. Provisional Patent Application No. 60/398,603, titled “Auto Power Down For Forced Speed Modes”, filed Jul. 26, 2002, the disclosure of which is incorporated herein by reference in its entirety.

### BACKGROUND OF THE INVENTION

1. Field of the Invention

The present invention relates to communication networks and, more particularly, to systems and methods for powering down transceivers in communications networks.

2. Background Art

In order to conserve power, a transceiver can be powered down when not communicating with a link partner or remote transceiver. Conventional methods and systems for powering down transceivers require monitoring of a receive path and a transmit path. It would be useful to be able to power down a transceiver without monitoring a transmit path.

What are needed, therefore, are methods and systems for powering down a transceiver, or portions thereof, without monitoring a transmit path.

### BRIEF SUMMARY OF THE INVENTION

The present invention is related to methods and systems for powering down transceivers without monitoring transmit paths.

The present invention is also related to methods and systems for auto power down in various speed modes in which network objects are operating. Specifically, one embodiment of the present invention has a local transceiver and a remote partner or transceiver interconnected via twisted wire pairs. One wire pair is designated as a receive wire pair. The other wire pair is designated as a transmit wire pair. Each transceiver has a receive wire pair and a transmit wire pair. A signal is transmitted via the transmit wire pair. The transceiver listens on the receive wire pair to determine whether a signal has been sent to the transceiver.

Each transceiver, whether local or remote, is operating as an equal partner with respect to the other in the system. In an embodiment, each transceiver listens only on its receive wire pair to determine whether data is being received by it. If no data is received by the transceiver, the transceiver will power down. In the power down mode, transceiver's circuits will go into low energy consumption mode or an “off” mode except for a receive wire pair monitoring circuit. The receive wire pair monitoring circuit will continue to monitor the receive wire pair to determine if data is being received by the transceiver. If data is received, the transceiver will not power down and stay connected to the other transceiver.

In one embodiment, a user can designate 10Base-T (IEEE 802.3 Ethernet Standard) mode of connection of transceivers in the system. In another embodiment, the user can designate 100Base-TX (IEEE 802.3 Ethernet Standard) mode of connection. The systems and methods of powering down the transceivers in these modes are slightly different. Nonetheless, transceivers will monitor the receive wire pair only in either embodiment. In yet another embodiment, transceivers may need to power down during Auto Negotiation. In this case, transceiver's monitoring circuits will also monitor the receive wire pair only.

An AUTO-MDIX function can be used to determine which is a correct wire pair to monitor. This function can be used in 10Base-T, 100Base-TX and/or Auto Negotiation modes. If it is not clear which wire pair is a receive wire pair or a transmit wire pair, AUTO-MDIX will determine which wire pair is the receive wire pair. After such determination, the transceiver will monitor the receive wire pair only.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1a is a system diagram illustrating an embodiment of an energy detect system, where a present invention can be implemented.

FIG. 1b is a system diagram illustrating another embodiment of an energy detect system, where a present invention can be implemented.

FIG. 2 illustrates an embodiment of a system where the present invention can be implemented, where a local transceiver is connected to a remote partner via a plurality of wire pairs.

FIG. 3a illustrates an embodiment of the present invention showing the local transceiver connected to the remote partner via receive and transmit wire pairs.

FIG. 3b illustrates another embodiment of the present invention operating in Auto Negotiation mode.

FIG. 4 is a flowchart diagram illustrating an embodiment of a method of operation of the system in the present invention.

FIG. 5 is a flowchart diagram illustrating another embodiment of a method of operation of the system in the present invention.

The present invention is described with reference to the accompanying drawings. In the drawings, like reference numbers indicate identical or functionally similar elements. Additionally, the leftmost digit of a reference number identifies the drawing in which the reference number first appears.

### DETAILED DESCRIPTION OF THE INVENTION

Table of Contents.

1. Overview.

2. Example Environment

3. Terminology.

4. Auto Power Down for Forced Speed Modes.

a. Force 10 Auto Power Down Mode.

b. Force 100 Auto Power Down Mode.

c. Auto Negotiation.

5. Method for Auto Power Down for Forced Speed Modes.

6. Conclusion.

1. Overview.

The present invention is directed to methods and systems for powering down transceivers without monitoring transmit paths. When no link partner is detected in the receive path after a wait period, a transceiver enters a lower-power-consumption mode, shutting down most of its functions, except for a circuit that continues to monitor the receive path.

Methods and systems for powering down a transceiver, or portions thereof, are taught in, for example, co-pending U.S. application titled, “Regulating Power Consumption for a Transceiver in a Communications Network,” [attorney docket BP1483], filed on [date], incorporated herein by reference in its entirety.

The situation is made more complicated when automatic crossover correction capability is added to the transceiver, which allows the receive pair and the transmit pair to swap functions when necessary. Methods and systems for identifying/designating receive and/or transmit paths are taught in, for example, U.S. application [to be assigned, Attorney docket BP 1520], titled Energy Detect with Auto Pair Select,” filed on [date], incorporated herein by reference in its entirety.

The inventions described in the above cited patent applications are useful, for example, when auto-negotiation is enabled, because they utilize the presence of maskable transmit link pulses. Not all users, however, use auto-negotiation. It would useful to allow those users to be able to implement an power down feature without enabling auto-negotiation. For example, forced speed modes, such as Force10 or Force100 speed modes, behave differently from auto-negotiation. Accordingly, a new method and system is described herein to allow forced speed modes to utilize power down features.

Operation of power down features of the invention, when operating in Force10 mode, is now described. When a local transceiver is forced to 10Base-T speed (10 megabits per second) of operation, the local transceiver continuously transmits short link pulses to inform a link partner (i.e., a remote transceiver) that a cable is connected between the local and remote transceivers. These link pulses are only transmitted on one of the two wire pairs, commonly called the transmit pair. The local transceiver listens on the other pair, the receive pair, to determine if a link partner is present. In order for this scheme to function properly, the transceiver needs to know which pair is the transmit pair, and which is the receive. Valid link (LINK PASS) cannot be achieved unless the local transceiver and the remote partner are transmitting on different wire pairs.

In accordance with the invention, the presence of a link partner is determined by monitoring for energy only on the wire pair currently designated as the receive pair.

When a function is employed to determine which is the correct receive pair to monitor, the function should be completed before the link can be achieved. Once the determination is made, the receive wire pair is monitored for incoming energy. The transmit wire pair is not monitored for incoming energy.

Operation of power down features of the invention, when operating in Force100 mode, is now described. When the local transceiver is forced to 100Base-TX speed (100 megabits per second) of operation, the local receive does not transmit link pulses. Instead, the local transceiver constantly transmits three-level signals of encoded symbols. When decoded by the remote transceiver, some of these symbols indicate packet data, while others indicate IDLE (lack of packets).

The power down feature in Force 100 mode is similar to the power down features in Force 10 mode. Transmit symbol streams are only transmitted on one of the two wire pairs, commonly called the transmit pair. The local transceiver listens on the other pair, the receive pair, to determine if a link partner is present.

In order for this scheme to function properly, the transceiver needs to know which pair is the transmit pair, and which is the receive pair. Valid link (LINK PASS) cannot be achieved unless the local transceiver and the remote partner are transmitting on different wire pairs.

The present invention thus determine the presence of a link partner by monitoring energy only on the wire pair currently designated as the receive pair.

When a function is employed to determine which is the correct receive pair to monitor, the function should be completed before the link can be achieved. Once the determination is made, the receive wire pair is monitored for incoming energy. The transmit wire pair is not monitored for incoming energy.

The present invention can operate in conjunction with auto-negotiation. During auto-negotiation, signals are transmitted between the local and remote transceivers. In accordance with the invention, receive path outputs of the energy detection system are suppressed during auto-negotiation to insure that the transceiver is not powered down during auto-negotiation. Since the present invention monitors the receive path but not the transmit path, transmit path outputs of the energy detection system do not need to be suppressed during auto-negotiate. In other words, knowledge of which wire pair is being used to transmit the link pulses can allow the energy detection suppression to only occur on the transmit wire pair detector. Energy detected on the receive pair is considered. The power down function thus will not “miss” individual link pulses from the partner that are inadvertently masked because they occur roughly simultaneously with the transmitted link pulses.

2. Example Environment

Example environments for the present invention are now described. Conventional communications networks are designed to have a hub and a plurality of devices connected to the hub. The devices and the hub can be connected via a single wire, a wire pair or any other means. Each device contains a transceiver to which the wire pairs are connected. Transceivers placed in devices are capable of communicating with other transceivers placed in other devices and the hub by detecting energy in the wire pair. The energy in the wire pair indicates presence of signals sent by transceivers, and, therefore, communication devices corresponding to those transceivers.

Each device in the communication network is connected using a receive wire pair and a transmit wire pair (or a single receive wire and a single transmit wire). The receive wire pair is used to receive a signal sent by another transceiver. The transmit wire pair is used to transmit a signal to another network device's transceiver.

If a transceiver determined that there is energy present on the other end of the wire pair, then a link is established between this transceiver and the transceiver of a device connected to the other end of the wire pair. Therefore, the signals are received and transmitted if links are formed between the transceivers of communication devices. To maintain links between devices, the energy must be monitored on wire pairs (whether receive wire pairs or transmit wire pairs) connecting the transceivers. If no energy is detected by a transceiver of a communication device, then no signal will be received or transmitted and a power down of the system will occur. In the power down mode, the transceiver will shut down most of its functional circuits except a circuit that monitors energy on the receive wire pair. In an embodiment, the transceiver may power down after a waiting period.

As the communications network becomes larger, it may be necessary for the receive wire pair and the transmit wire pair to swap functions, because transceivers are receiving and/or transmitting on wrong wire pairs. This is called crossover. A method and system for dealing with this problem is suggested in the U.S. patent application Ser. No. 09/928,622 to Berman et al., which is incorporated herein by reference in its entirety.

It is often that Ethernet systems (defined by IEEE 802.3 standard) or local area networks (LAN) implement above described methods of receiving and transmitting signals via receive and transmit wire pairs, respectively. Ethernet networks typically have an Ethernet transceiver capable of transmitting or receiving signals within the network. In order to operate, the transceivers draw power from the network's power supply (network power supply or a separate transceiver power supply or any other power supply providing power to the transceiver). Ethernet transceivers draw a relatively substantial amount of electrical power and present a problem of power shortage. For example, this is especially problematic with portable or laptop computers. When these computers are transported, users typically do not remove their network interface cards (NIC). Therefore, even when NIC is not used, a transceiver connected to the NIC continues to check for signals present in the card, thus, drawing power from the power supply of the computer.

Therefore, there is a need for a system that is capable of conserving power in a network by limiting the amount of energy consumed by a transceiver. The system should be able to monitor presence of energy in wire pairs connecting network transceivers and power down the transceivers if no energy is present.

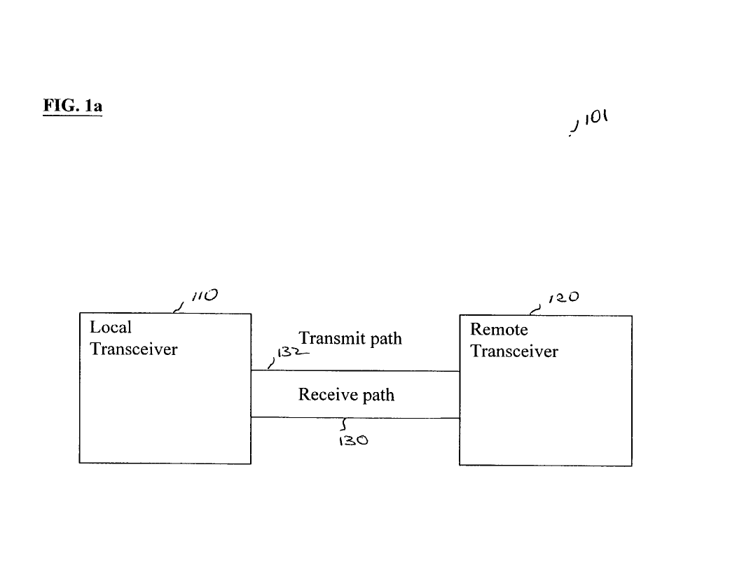

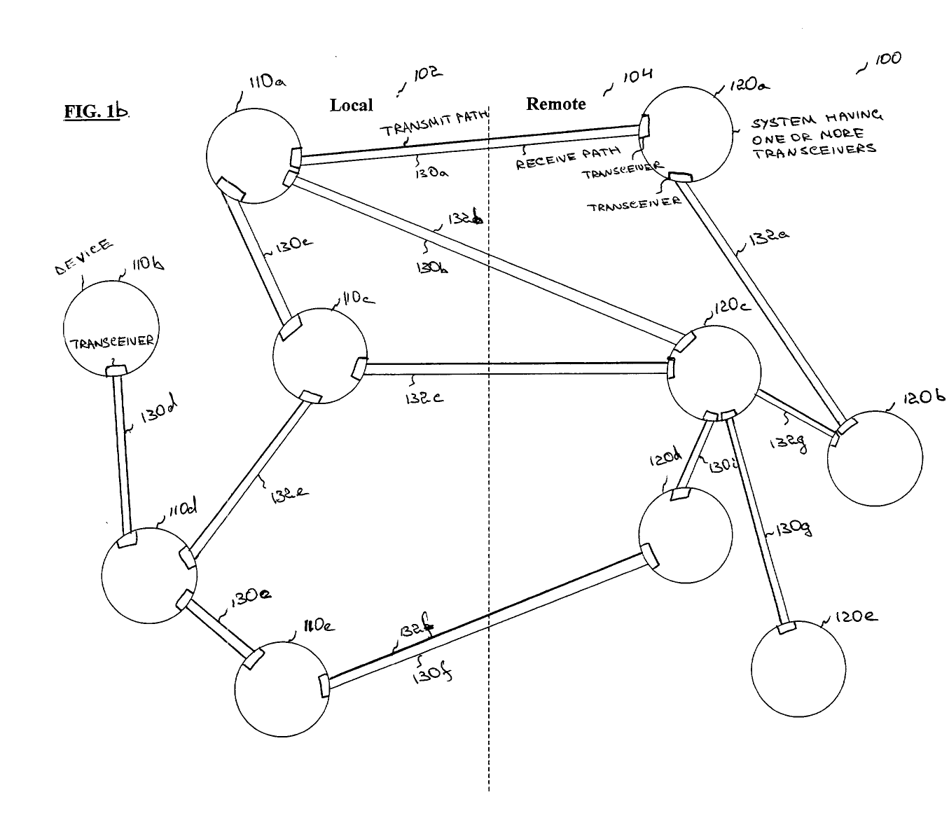

FIG. 1a is a system diagram illustrating an example network system 101, where the present invention can be implemented. The network system 101 includes a local transceiver 110 and a remote transceiver 120. The designation of local transceiver 110 as local is arbitrary. Similarly, the designation of remote transceiver 120 as remote is arbitrary. A receive path 130 interconnects local transceiver 110 and remote transceiver 120. Also, a transmit path 132 interconnects local transceiver 110 and remote transceiver 120.

FIG. 1b is a system diagram illustrating an example network system 100, where the present invention can be implemented. The network system 100 includes an arbitrary local side 102 and an arbitrary remote side 104. Local side 102 has local transceivers 110 and remote side 104 has remote transceivers 120. A local transceiver 110 can have a transceiver partner. The transceiver partner may be another local transceiver 110 or remote transceiver 120. Similarly, a remote transceiver 120 can have a transceiver partner. The transceiver partner for remote transceiver 120 can be local transceiver 110 or another remote transceiver 120.

Local transceivers 110 and remote transceivers 120 are interconnected by wire pairs 130 and 132. Wire pairs 130 are designated as receive wire pairs. Wire pairs 132 are designated as transmit wire pairs. Receive wire pairs 130 allow a transceiver (whether remote or local) to receive signals from another transceiver. Transmit wire pairs 132 allow a transceiver to transmit signals to the other transceiver. It is understood by one having ordinary skill in the art that transceivers may be connected via single wires as well as wire pairs.

Local transceivers 110 can be interconnected by receive wire pairs 130 as well as transmit wire pairs 132. For example, a local transceiver 110a is connected by a receive wire pair 130c with a local transceiver 110c. Similarly, a local transceiver 110d is connected by a transmit wire pair 132e with local transceiver 110c.

Analogously, remote transceivers 120 can be interconnected by receive wire pairs 130 as well as transmit wire pairs 132. For example, a remote transceiver 120a is connected by a transmit wire pair 132a with a remote transceiver 120b. Similarly, remote transceiver 120c is connected by a receive wire pair 130i with remote transceiver 120d.

Local transceivers 110 and remote transceivers 120 can be connected by receive wire pairs 130, transmit wire pairs 132 or both. For example, local transceiver 110a is connected to remote transceiver 120a by a receive wire pair 130a. Similarly, a local transceiver 110c is connected with remote transceiver 120c by a transmit wire pair 132c. Finally, local transceiver 110a is connected to remote transceiver 120c via a receive wire pair 130b and a transmit wire pair 132b.

The designation of “local transceiver” and “remote transceiver” can be used interchangeably. Each transceiver operates independently of the other transceiver. Therefore, each transceiver can be considered local with respect to the other transceiver. The opposite is also true, each transceiver can be considered remote with respect to the other transceiver. It is understood by one of ordinary skill in the art that “local” and “remote” representations are for illustrative purposes only.

It is further understood by one of ordinary skill in the art that other systems representing networks having transceivers are possible and that the present invention is not limited to the one described in FIGS. 1a and 1b. The following is a terminology section where terms that are used in the description of the present invention are described. One of ordinary skill in the art understands that the present invention is not limited to the following terms.

3. Terminology.

To more clearly delineate the present invention, an effort is made throughout the specification to adhere to the following term definitions as consistently as possible.

“10Base-T” is a 10Mbits-per-second (“bps”) Ethernet standard (IEEE 802.3u standard) that uses twisted wire pairs (e.g., a telephone wire).

Transceivers are connected in a star configuration to a central hub, which is also known as a “multiport repeater,” or to a central switch. 10Base-T is used because of its low cost and flexibility of installing twisted pair.

“100Base-T” is a 100Mbps Ethernet (IEEE 802.3u standard). 100Base-T transmits 100Mbps instead of 10Mbps as in 10Base-T case. Transceivers in this system share a 100Mbps bandwidth.

“Ethernet” (IEEE 802.3 standard) is a shared media Local Area Network (“LAN”), where transceivers share a total bandwidth, which can be 10Mbps (Ethernet), 100Mbps (Fast Ethernet) or 1000Mbps (Gigabit Ethernet). Ethernet is the most popular type of local area network, which sends its communications through radio frequency signals carried by a cable. Each transceiver checks to see if another transceiver is transmitting and waits its turn to transmit. If two transceivers accidentally transmit at the same time and their messages collide, they wait and send again in turn. Software protocols used by Ethernet systems vary, but can include Novell NetWare and TCP/IP.

“Transceiver” is a transmitter and/or receiver of analog or digital signals. It may comes in many forms, for example: a transponder, a network adapter or other network device.

“Twisted pair” is a pair of relatively thin diameter wire commonly used for telephone and network cabling. The wires are twisted around each other to minimize interference from other twisted pairs in the cable. Twisted pairs have less bandwidth than coaxial cable or optical fiber. Twisted pairs are available in unshielded (UTP) or shielded (STP). STP is used in noisy environments where the shield protects against excessive electromagnetic interference. Both UTP and STP come in stranded and solid varieties. Stranded variety is more flexible, whereas solid variety has less attenuation and can span longer distances and less flexible than stranded wire.

4. Auto Power down for Forced Speed Modes.

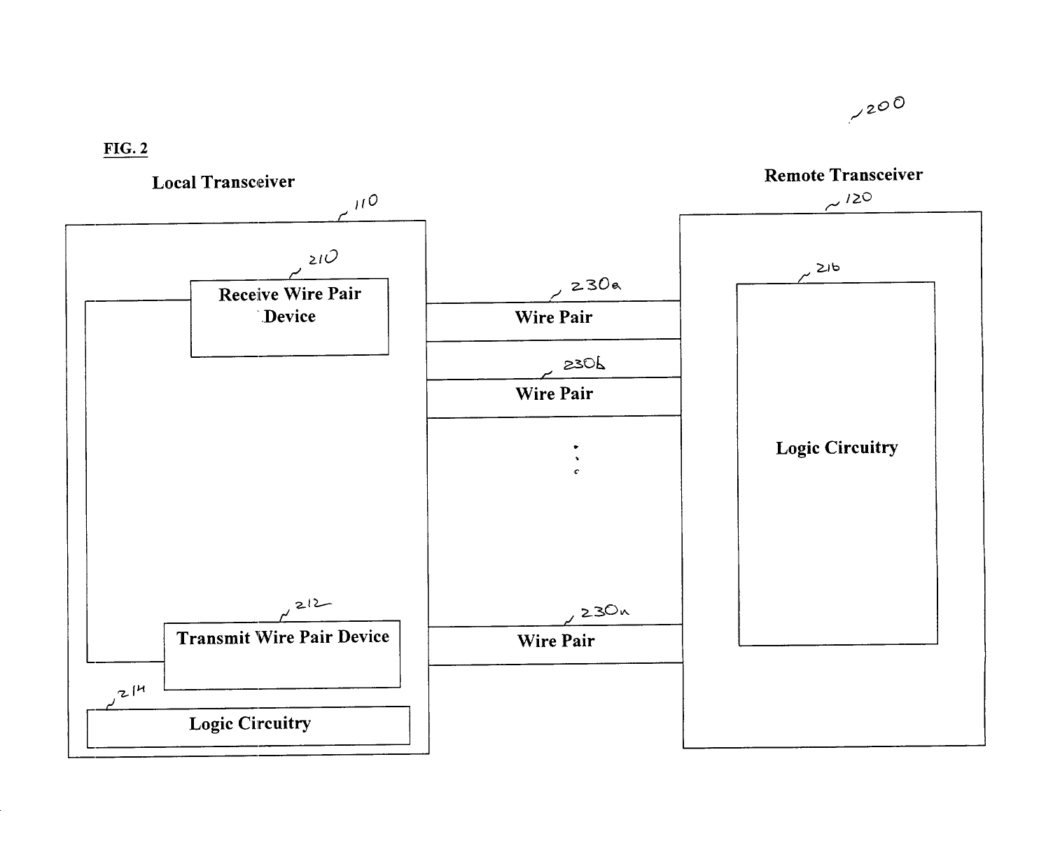

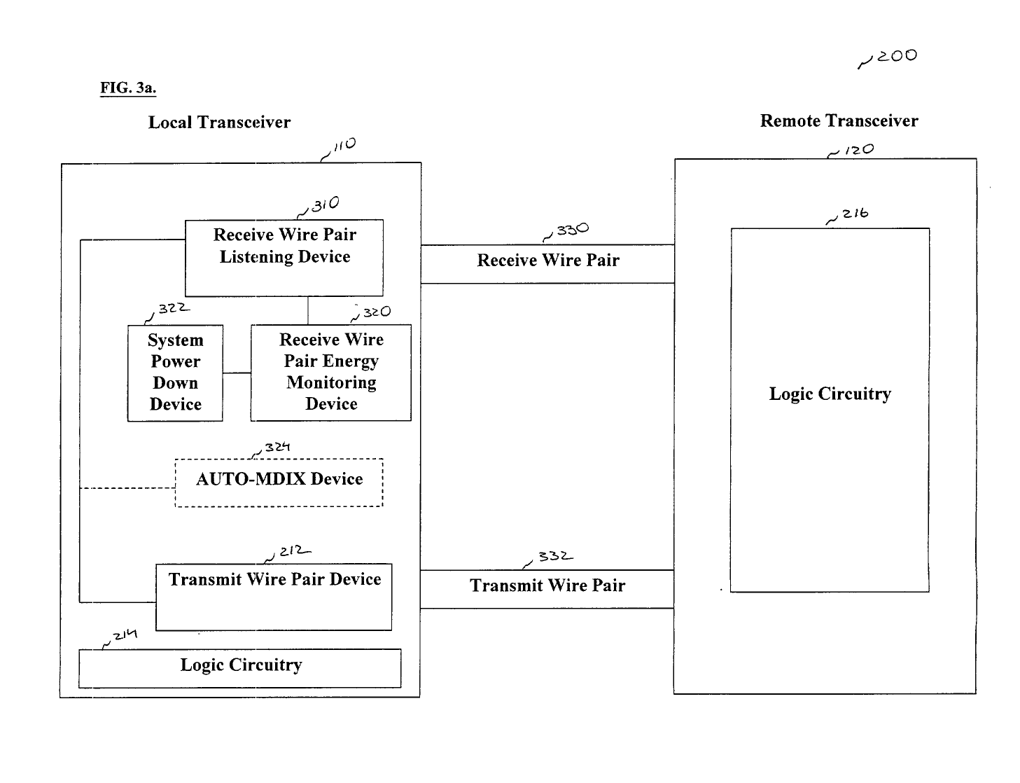

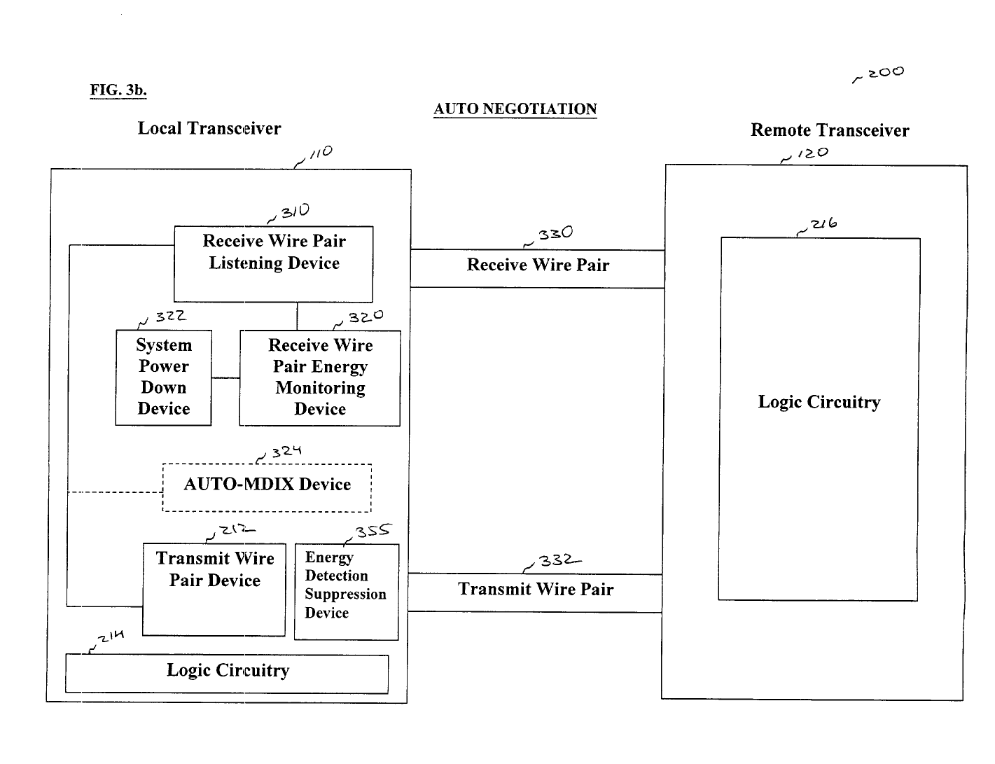

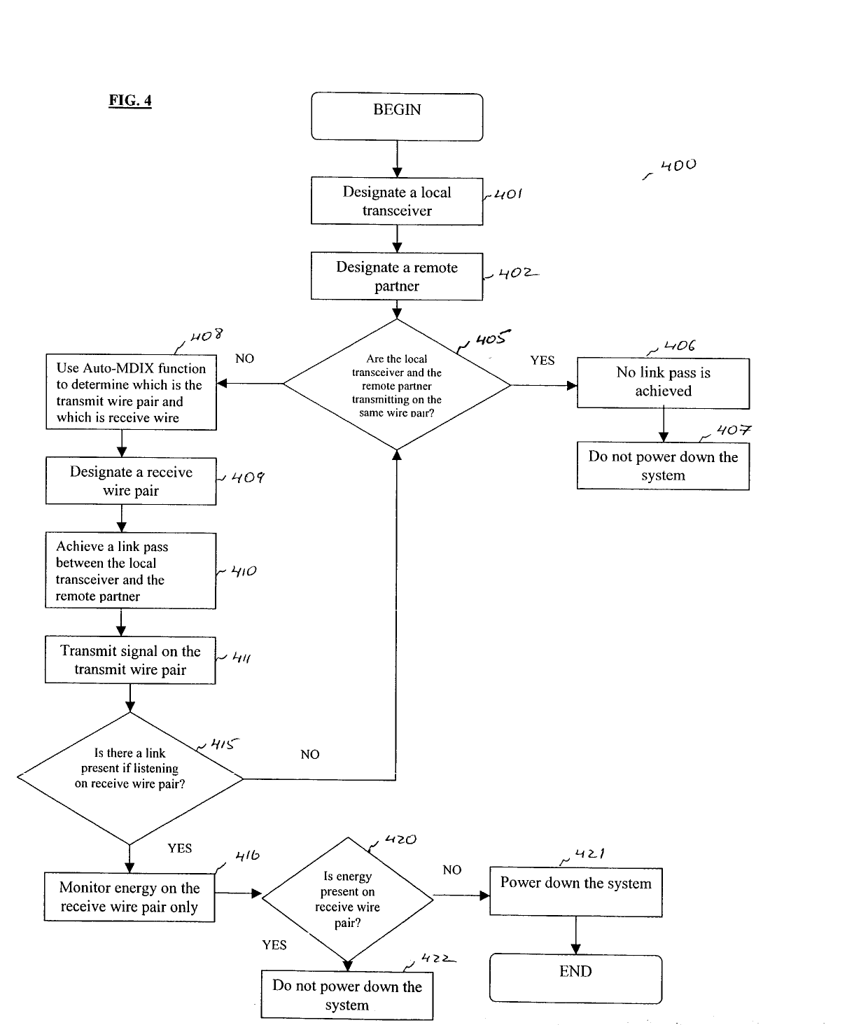

An embodiment of the present invention is described with respect to FIGS. 2, 3a and 3b. A method of operation of the embodiment of the system described in FIGS. 2, 3a and 3b is shown in FIG. 4.

FIG. 2 is a block diagram of a network system 200, including a pair of transceivers from FIGS. 1a and 1b. FIG. 2 shows a local transceiver 110, a remote transceiver 120, and a plurality of wire pairs 230 connecting local transceiver 110 and remote transceiver 120.

Local transceiver 110 includes a receive wire pair device 210, a transmit wire pair device 212 and logic circuitry 214. Remote transceiver, or remote partner, 120 includes logic circuitry 216. Logic circuitry 216 may be similar in structure to the structure of local transceiver 110. Logic circuitry 216 can include a receive wire pair device similar to receive wire pair device 210 and a transmit wire pair device similar to transmit wire pair device 212.

Local transceiver 110 and remote transceiver 120 are interconnected by plurality of wire pairs 230 (a, b, . . . n). Each wire pair 230 is either a receive wire pair or a transmit wire pair. For the purposes of an example, assume that wire pair 230a is a receive wire pair 230a and wire pair 230n is a transmit wire pair 230n. Receive wire pair device 210 is connected to receive wire pair 230a and receives a signal or data packets sent through the receive wire pair 230a from remote transceiver 120.

Likewise, transmit wire pair device 212 is connected to transmit wire pair 230n and transmits signals or data packets to remote transceiver 120 via transmit wire pair 230n. The designations of transmit wire pair and receive wire pair can be made by the user or by the system.

FIG. 3a is a more detailed block diagram of the network system 200. FIG. 3a shows local transceiver 110, remote transceiver 120, a receive wire pair 330 and a transmit wire pair 332. Local transceiver 110 and remote transceiver 120 are connected via receive wire pair 330 and transmit wire pair 332. Remote transceiver 120 is another transceiver in system 200.

In the example of FIG. 3a, the local transceiver 110 further includes a receive wire listening device 310, a receive wire pair energy monitoring device 320, a system power down device 322, transmit wire pair device 212, logic circuitry 214 and an optional AUTO-MDIX device 324.

Receive wire pair listening device 310 is connected to receive wire pair energy monitoring device 320, which in turn is connected to system power down device 322. Transmit wire pair device 212 is connected to receive wire pair listening device 310. Optional AUTO-MDIX device 324, when implemented, is connected to receive wire pair listening device 310 and transmit wire pair device 212.

Remote transceiver 120 may be similarly structured as local transceiver 110. Local transceiver 110 receives signals or data packets through receive wire pair 330, which connects remote transceiver 120 and local transceiver 110. Local transceiver 110 transmits signals or data packets to remote transceiver 120 through transmit wire pair 332, which also connects local transceiver 110 and remote transceiver 120. Receive wire pair 330 is similar to receive wire pairs 130, described in FIGS. 1a and 1b. Transmit wire pair 332 is similar to transmit wire pairs 132, also described in FIGS. 1a and 1b.

It is understood by one having ordinary skill in the art that the present invention is not limited to the structure described in FIG. 3a. The following is a description of auto power down operating in various speed modes.

The present invention can operate in various environments or speed modes. For the illustrative purposes, three operational environments will be discussed: Force 10, Force 100 and Auto Negotiation. System in Force 10 mode operates in a 10Base-T (IEEE 802.3 Standard) environment. System in Force 100 mode operates in a 100Base-TX (IEEE 802.3 Standard) environment. Auto Negotiation is a pre-operation mode, or a pre-connection mode, where transceivers in a system are trying to establish connection via wire pairs. This is sometimes referred to as “handshaking”. Transceivers exchange signals between each other to determine a presence of a link partner on the other end of a wire pair.

a. Force 10 Auto Power Down Mode.

In an embodiment, the network system 200 may be operating in the Force 10 mode. A user may desire such operation speed or components in the system are configured to operate using 10Base-T connection speed. In 10Base-T mode, a transceiver in the system, such as a local transceiver 110, continuously transmits short link pulses to inform a potential link partner that the transceiver is available for receiving and transmitting signals. The link pulses are commonly transmitted on a transmit wire pair connecting the transceiver and the link partner. The transceiver listens and monitors the other connecting wire pair, i.e., the receive wire pair, to determine whether a potential link partner is transmitting. In this case, the transceiver needs to know which wire pair is the receive wire pair and which one is the transmit wire pair. A valid link between the transceiver and its link partner is not achieved unless transceiver possesses such knowledge.

In an embodiment of the present invention, once the transceiver determines which wire pair is the receive wire pair, the transceiver monitors the receive wire pair for presence of energy present. This is an advantage over other systems, where monitoring is performed on both wire pairs. By monitoring energy on the receive wire pair only, the present invention saves more energy by not monitoring energy on the transmit wire pair.

Referring to FIG. 3a, when network system 200 operates in 10Base-T speed mode, then local transceiver 110 transmits link pulses to remote transceiver 120. The link pulses are transmitted via transmit wire pair 332 and inform remote transceiver 120 that local transceiver 110 is available.

While the pulses are transmitted via transmit wire pair 332, local transceiver 110 is listening on receive wire pair 330 to determine if a link partner is available or active. Local transceiver 110 is listening using receive wire pair listening device 310. If receive wire pair listening device 310 determines that a link partner is present, it sends an appropriate signal to local transceiver 110 informing it that the link partner (remote transceiver 120) is present. If receive wire pair listening device 310 determines that a link partner is not present, no link is established between local transceiver 110 and remote transceiver 120.

For the above scheme to operate properly, local transceiver 110 should know which wire pair is the receive wire pair and which one is the transmit wire pair. In one embodiment, a user designates the receive wire pair. In another embodiment, there is a standardized agreement as to which wire pair is the receive wire pair and which one is the transmit wire pair. FIG. 3aillustrates that the receive wire pair is designated as receive wire pair 330 and the transmit wire pair is designated as transmit wire pair 332.

In yet another embodiment, a separate function—AUTO-MDIX function—can be implemented to determine which pair is the receive wire pair. Using the automatic media dependent interface crossover function, or the AUTO-MDIX function, the transceiver automatically detects which pair is the receive wire pair and which pair is the transmit wire pair. If a signal is transmitted via a wrong wire pair, the AUTO-MDIX function automatically switches the transceiver to the correct wire pair and continue transmission via correct wire pair.

Referring back to FIG. 3a, an optional AUTO-MDIX function 324 is shown by a dashed line. AUTO-MDIX function 324 is connected to receive wire pair listening device 310 and transmit wire pair device 212. Therefore, if a signal is transmitted via receive wire pair 330, AUTO-MDIX function 324 switches local transceiver 110 to transmit signals via transmit wire pair 332. AUTO-MDIX function 324 is not needed by the system, if wire pairs have been pre-selected. AUTO-MDIX function 324 is further described in the U.S. patent application Ser. No. 09/928,622 to Berman et al., filed Aug. 13, 2001, which is incorporated herein by reference in its entirety.

When the link pulses are transmitted via transmit wire pair 332, local transceiver 110 listens on receive wire pair 330 to determine whether link to remote transceiver 120 is still present. Receive wire pair energy monitoring device 320 monitors receive wire pair 330 to determine whether energy is present on receive wire pair 330. If energy is present on receive wire pair 330, receive wire pair energy monitoring device 320 informs local transceiver 110 that remote transceiver 120 is connected to local transceiver 110 and that local transceiver 110 need not power down.

However, if receive wire pair energy monitoring device 320 detects insufficient energy in receive wire pair 330, monitoring device 320 triggers system power down device 322. System power down device 322 automatically powers down local transceiver 110 circuits, except a circuit that monitors receive wire pair 330. In other words, receive wire pair energy monitoring device 320 continues monitoring receive wire pair 330 for presence of energy.

Furthermore, since local transceiver 110 and remote transceiver 120 are operating as separate entities, local transceiver 110 cannot power down its remote transceiver 120. Converse is also true, remote transceiver 120 cannot power down local transceiver 110.

b. Force 100 Auto Power Down Mode.

Force 100 is another environment where system 200 can operate. Force 100 refers to 100Base-TX speed of connection between a local transceiver and its remote transceiver. When a transceiver operates in 100Base-TX speed mode, link pulses are not transmitted. This is contrary to Force 10 mode of operation. In Force 100, the transceiver is constantly transmitting a three-level signal through the transmit wire pair. The three-level signal consists of encoded symbols. When three-level signals are decoded by a receiver, some of the encoded symbols can be in the form of packet data and others can be IDLE data, indicating lack of data packets.

Referring to FIG. 3a, during Force 100 mode, local transceiver 110 transmits three level signals via transmit wire pair 332. Local transceiver 110 listens on receive wire pair 330 to determine whether remote transceiver 120 is present. In Force 100, as in Force 10, local transceiver 110 must know which wire pair is the receive wire pair.

As described with respect to Force 10 mode, the receive wire pair can be designated by the user or by a standardized agreement as to which wire pair is the receive wire pair. In another embodiment, optional AUTO-MDIX function 324 can be implemented to determine which wire pair is the receive wire pair. As described above, AUTO-MDIX function 324 switches local transceiver 110 to transmit wire pair 332, if local transceiver 110 transmits three level signals on a wrong wire pair.

AUTO-MDIX function 324 is described in the U.S. patent application Ser. No. 09/928,622 to Berman et al., filed Aug. 13, 2001, which is incorporated herein by reference in its entirety.

Similarly to Force 10 mode of operation, when three level signals are transmitted via transmit wire pair 332, local transceiver 110 listens on receive wire pair 330 to determine whether remote transceiver 120 is connected to local transceiver 110. Receive wire pair energy monitoring device 320 monitors receive wire pair 330 to determine whether energy is present in receive wire pair 330. If energy is present in receive wire pair 330, receive wire pair energy monitoring device 320 informs local transceiver 110 that remote transceiver 120 is connected to local transceiver 110. In this case, local transceiver 110 does not power down.

However, if receive wire pair energy monitoring device 320 does not detect energy in receive wire pair 330, monitoring device 320 triggers system power down device 322. System power down device 322 powers down local transceiver 110 circuits, except a circuit that monitors receive wire pair 330. In other words, receive wire pair energy monitoring device 320 continues monitor receive wire pair 330 for a presence of energy.

Furthermore, as in Force 10, since local transceiver 110 and remote transceiver 120 are operating as separate entities, local transceiver 110 cannot power down its remote transceiver 120. Converse is also true, remote transceiver 120 cannot power down local transceiver 110.

c. Auto Negotiation Power Down Mode.

The Auto Negotiation is a pre-operation, or pre-connection, environment of network system 200. In some systems, only in this environment auto power down of transceivers is allowed. This environment is sometimes referred to as a “handshaking” mode, where transceivers are exchanging a series of signals to determine whether there is a connection between them.

Auto Negotiation environment of operation can also employ AUTO-MDIX function to determine over which wire pair (or a single wire) signal transmission should be carried.

Furthermore, during signal transmission by either the local transceiver or the remote transceiver, transceivers' energy detecting devices are outputting data relating to presence of energy on the wire pairs. In existing systems, the output of energy detecting devices is suppressed during and shortly after the transmission of signals between local and remote transceivers. This causes the transceivers to continue sending signals via wire pairs even if there is no remote transceiver on the other end. Because signals are transmitted, the transceiver cannot power down, even when it has to.

FIG. 3b is a block diagram of the network system 200 in Auto Negotiation environment. Network system 200 includes all of the elements of FIG. 3a, and includes an energy detection suppression device 355. Energy detection suppression device 355 is a part of local transceiver 110. Energy detection suppression device 355 is used during Auto Negotiation, as described below.

In an embodiment of the present invention, network system 200 already knows that the designated receive wire pair is receive wire pair 330 and the designated transmit wire pair is transmit wire pair 332. The energy in receive wire pair 330 is detected by receive wire pair energy monitoring device 320. Unlike existing systems, the output of receive wire pair energy monitoring device 320 is not suppressed. Such output is considered by local transceiver 110 in determining whether link partner is present.

On the other hand, energy detection suppression device 355 acts to monitor and suppress energy detected in transmit wire pair 332 when signals are transmitted from remote transceiver 120 via transmit wire pair 332. In this case, system power down device 322 will not power down the system when individual pulses are transmitted from remote transceiver 120.

Presence of energy detection suppression device 355 only with respect to transmit wire pair 332 allows system 200 to power down when no energy is detected on receive wire pair 330. In this case, local transceiver 110 does not transmit any signals to remote transceiver 120.

5. Method for Auto Power Down for Forced Speed Modes.

FIG. 4 is a flowchart diagram showing method 400 for auto power down in accordance with the invention. It is understood by one having ordinary skill in the art that other embodiments of the method are possible.

In step 401, a local transceiver is designated. This is shown as local transceiver 110 in FIGS. 3a and 3b. Step 402 designates local transceiver's 110 remote partner (which is shown as remote transceiver 120 in FIGS. 3a and 3b).

In step 405, a determination is made as to whether local transceiver 110 and its remote transceiver 120 are transmitting over the same wire pair, then a valid link pass between local transceiver 110 and remote transceiver 120 cannot be achieved, as shown in step 406. If the valid link pass cannot be achieved between local transceiver 110 and remote transceiver 120, local transceiver 110 is not powered down (Step 407).

Referring back to step 405, if local transceiver 110 and remote transceiver 120 are transmitting over different wire pairs, processing proceeds to step 408 for designation of a receive wire pair. In step 408, if local transceiver 110 and remote transceiver 120 are communicating on wrong wire pairs, AUTO-MDIX function 324 can be used to determine which wire pair is the receive wire pair and which one is the transmit wire pair. In step 409, receive wire pair 330 is designated as the proper receive wire pair and transmit wire pair 332 is designated as the proper transmit wire pair.

In step 410, a link pass is achieved between local transceiver 110 and remote transceiver 120. In step 411, a signal is transmitted on transmit wire pair 332.

In decision step 415, receive wire pair listening device 310 listens on receive wire pair 330 to determine if the link between local transceiver 110 and remote transceiver 120 is present. If link is not present, returns to decision step 405 to determine whether local transceiver 110 and remote transceiver 120 are transmitting on the same wire pair.

If link is present, processing proceeds to step 416, where receive wire pair energy monitoring device 320 monitors energy on receive wire pair 330. In step 420, if energy is not present, in receive wire pair 330, processing proceeds to step 421, where receive wire pair energy monitoring device 320 triggers system power down device 322 to power down local transceiver 110. Local transceiver 110 powers down except receive wire pair energy monitoring device 320 that monitors energy on receive wire pair 330.

Referring back to step 420, if energy is present in receive wire pair 330, processing proceeds to step 422, where local transceiver 110 does not power down. This means that remote transceiver 120 continues communicating with local transceiver 110.

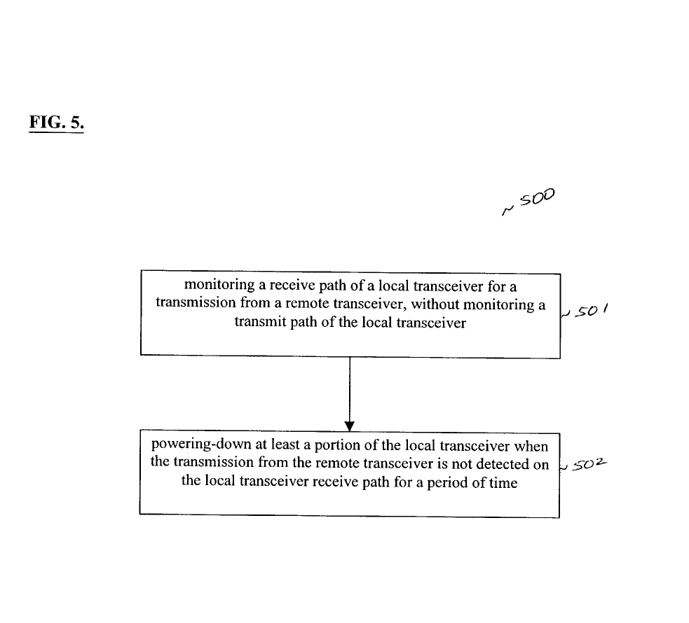

FIG. 5 is a flowchart diagram showing method 500 for auto power down in accordance with the invention. In step 501, receive path 130 of local transceiver 110 is monitored for any transmission from remote transceiver 120. The receive path 130 is monitored without monitoring transmit path 132 of local transceiver 110. The processing then proceeds to step 502.

In step 502, at least a portion of the local transceiver 110 is powered down, when local transceiver 110 does not detect any transmission from remote transceiver 120 for some period of time.

It is understood by one having ordinary skill in the are that other embodiments of methods 400 and 500 are possible. Powering down system 200 is not limited to steps described in FIGS. 4 and 5.

6. Conclusion.

Example embodiments of the methods, circuits, and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. A method for powering down circuitry in a local transceiver, comprising:
(1) monitoring a receive path of said local transceiver for a transmission from a remote transceiver, without monitoring a transmit path of said local transceiver; and
(2) powering-down at least a portion of said local transceiver when said transmission from said remote transceiver is not detected on said local transceiver receive path for a period of time.

2. The method according to claim 1, further comprising, prior to said steps (1) and (2):
(3) determining which of a first and second local transceiver path is said receive path.

3. The method according to claim 1, wherein said local transceiver is designed to operate in a 10 Mega Bit per second, forced speed, non-auto-negotiate mode, and designed to transmit link pulses on said transmit path.

4. The method according to claim 1, wherein said local transceiver is designed to operate in a 100 Mega Bit per second, forced speed, non-auto-negotiate mode, and designed to transmit a three-level signal including encoded symbols on said transmit path.

5. The method according to claim 1, wherein said local transceiver transmits auto-negotiate data on said local transceiver transmit path, and wherein step (1) comprises monitoring said local transceiver receive path for said transmission from a remote transceiver, without suppressing said local transceiver transmission of said auto-negotiate data.

6. The method according to claim 1, wherein step (2) comprises not powering down circuitry that monitors said receive path of said local transceiver for said transmission from said remote transceiver.

7. A method for powering down a transceiver, comprising:
(a) determining whether the transceiver is transmitting on a wire that a remote transceiver is transmitting on;
(b) disconnecting the transceiver and the remote transceiver if the transceiver and remote transceiver are communicating via identical wire pairs, otherwise designating a receive wire pair and a transmit wire pair;
(c) transmitting a signal via the transmit wire pair;
(d) monitoring the receive wire pair only;
(e) powering down the system if no energy is detected on the receive wire pair.

8. The method of claim 7, wherein said step (a) further comprising:
operating the transceiver in 10Base-T speed mode.

9. The method of claim 7, wherein said step (a) further comprising:
operating the transceiver in 100Base-TX mode.

10. The method of claim 7, wherein said step (a) further comprising:
operating the transceiver and the remote transceiver in Auto Negotiation.

11. A method for powering down a transceiver system, comprising:
(a) designating a first plurality of wire pairs coupling the transceiver, as receive wire pairs;
(b) designating a second plurality of wire pairs coupling the transceiver system, as transmit wire pairs;
(c) transmitting a signal using the transmit wire pairs;
(d) monitoring the receive wire pairs for energy;
(e) powering down the transceiver system when no energy is detected on the first plurality of wire pairs.

12. The method of claim 11, wherein said step (a) further comprises terminating a connection in the transceiver system when the transceiver system is using identical wire pairs to receive and transmit signals.

13. The method of claim 11, wherein said step (d) further comprises: determining a receive wire pair, from the first plurality of wire pairs, to monitor for incoming energy.

14. The method of claim 11, wherein said step (a) further comprising:
operating the transceiver system in 10Base-T speed mode.

15. The method of claim 11, wherein said step (a) further comprising:
operating the transceiver system in 100Base-TX mode.

16. The method of claim 11, wherein said step (a) further comprising:
operating the transceiver system in Auto Negotiation.

17. A system for forcing a power down of a transceiver system coupled by a plurality of wire pairs, comprising:
a receive wire pair, wherein said receive wire pair is one of the plurality of wire pairs and connects the transceiver system;
a transmit wire pair, wherein said transmit wire pair is one of the plurality of wire pairs and connects the transceiver system;
a local transceiver device for distinguishing between said receive wire pair and said transmit wire pair;
a local transceiver signal transmission device for transmitting signals over said transmit wire pair;
an energy monitoring device for monitoring said receive wire pair, wherein energy is received by said receive wire pair to indicate power consumption of the transceiver system;
a power down device, wherein said power down device is activated when insufficient energy is detected on said receive wire pair.

18. The system of claim 17, wherein the transceiver system is configured to operate in 10Base-T speed mode.

19. The system of claim 17, wherein the transceiver system is configured to operate in 100Base-TX mode.

20. The system of claim 17, wherein the transceiver system are in Auto Negotiation.

21. A transceiver configured to power down when no energy is present on a plurality of receive wire pairs connecting the transceiver and a remote transceiver, comprising:
a plurality of transmit wire pairs connecting the transceiver and the remote transceiver;
a means for transmitting a signal over said plurality of transmit wire pairs;
a means for monitoring the plurality of receive wire pairs;
a means for powering down the system when no energy is detected at the plurality of receive wire pairs.

22. The system of claim 21, wherein said transceiver further comprises a means for determining which receive wire pairs to monitor.

23. The system of claim 21, wherein the transceiver is configured to operate in 10Base-T speed mode.

24. The system of claim 21, wherein the transceiver is configured to operate in 100Base-TX mode.

25. The system of claim 21, wherein the transceiver and the remote transceiver are in Auto Negotiation.
